(19) United States
(12) Patent Application Publication
(10) Pub. No.: US 2014/0070013 A1
(43) Pub. Date: Mar. 13, 2014

(54) THERMAL SYSTEM AND METHOD FOR A VEHICLE HAVING TRACTION BATTERY

(71) Applicants: Joseph F. Stanek, Northville, MI (US); Brian Gillespey, Brownstown, MI (US); Kenneth J. Jackson, Dearborn, MI (US); Mark G. Smith, Canton, MI (US); Scott Wojtkowicz, Livonia, MI (US); Andy Kummer, South Lyon, MI (US); Christopher Adam Ochocinski, Canton, MI (US)

(72) Inventors: Joseph F. Stanek, Northville, MI (US); Brian Gillespey, Brownstown, MI (US); Kenneth J. Jackson, Dearborn, MI (US); Mark G. Smith, Canton, MI (US); Scott Wojtkowicz, Livonia, MI (US); Andy Kummer, South Lyon, MI (US); Christopher Adam Ochocinski, Canton, MI (US)

(73) Assignee: FORD GLOBAL TECHNOLOGIES, LLC, Dearborn, MI (US)

(21) Appl. No.: 13/611,101

(22) Filed: Sep. 12, 2012

(51) Int. Cl. B60H 1/22

(52) U.S. Cl. 237/28; 237/81

(57) ABSTRACT

A thermal system for an electric vehicle includes an electric heat source, a heat exchanger, a traction battery, a first thermal loop thermally coupled to the heat exchanger and the heat source, and a second thermal loop thermally coupled to the battery and configured to be selectively thermally coupled to the heat source. A vehicle includes an electric heat source, a heat exchanger system selectively thermally coupled with the heat source, and a traction battery system selectively thermally coupled to the heat source. A method of controlling a battery electric vehicle includes detecting a vehicle state input and operating an electric heater to heat a fluid. A valve arrangement is actuated to provide the fluid to one of a traction battery through a first fluid conduit, a heat exchanger through a second fluid conduit, and a battery and a heat exchanger through the first and second fluid conduits.

### TECHNICAL FIELD

Various embodiments relate to a thermal system and a method of controlling the thermal system for a vehicle having a traction battery.

### BACKGROUND

Electric vehicles require a heat source for both the propulsion battery and passenger compartment. Since normal ICE waste engine heat is not available for a battery electric vehicle (BEV), and may be limited for other hybrids such as a plug-in electric hybrid vehicle (PHEV), alternative heating systems need to be provided in the vehicle. High voltage batteries are heated based on reductions in performance or charging capacities in temperature extremes. Passenger compartment or cabin heating using a heating, ventilation, and air conditioning (HVAC) system is desirable for passenger comfort. The vehicle battery and passenger compartment may be heated during use of the vehicle and may also be preconditioned and heated during charging or prior to usage. Various prior art thermal systems for vehicles use multiple heating devices with duplicate functionality such that the passenger cabin has a heating device, and the battery has a separate heating device, which leads to additional wiring, high current electrical components, and controls.

### SUMMARY

In an embodiment, a thermal system for an electric vehicle is provided with an electric heat source, a heat exchanger, and a traction battery. A first thermal loop is thermally coupled to the heat exchanger and is thermally coupled to the heat source. A second thermal loop is thermally coupled to a traction battery and is configured to be selectively thermally coupled to the heat source.

In another embodiment, a vehicle is provided with an electric heat source, a heat exchanger system configured to be selectively thermally coupled with the electric heat source, and a traction battery system configured to be selectively thermally coupled to the electric heat source.

In yet another embodiment, a method of controlling a battery electric vehicle is provided. A vehicle state input is detected. An electric heater is operated to heat a fluid. A valve arrangement is actuated in response to detecting the vehicle state input to provide the fluid to at least one of a traction battery through a first fluid conduit and a heat exchanger through a second fluid conduit.

Various embodiments according to the present disclosure have associated advantages. For example, embodiments according to the present disclosure provide for a single heater to heat the battery and act as a heat source for the HVAC system, which reduces number of heaters on-board the vehicle and provides a higher power capability to meet thermal heating needs of the traction battery during cold temperature extremes. The valving arrangement between the battery thermal loop and the HVAC thermal loop allows for control over heat transfer to the battery and the heat exchanger of the HVAC system. For example, the valve arrangement may be controlled for variable or blended heating between the two loops based on the vehicle state and any user inputs.

### BRIEF DESCRIPTION OF THE DRAWINGS

FIG. 1 illustrates a schematic of a vehicle capable of implementing an embodiment;

FIG. 2 illustrates a schematic of a thermal system according to an embodiment; and

FIG. 3 illustrates a flowchart for a method of using the thermal system of FIG. 2 according to an embodiment.

### DETAILED DESCRIPTION

As required, detailed embodiments of the present disclosure are disclosed herein; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

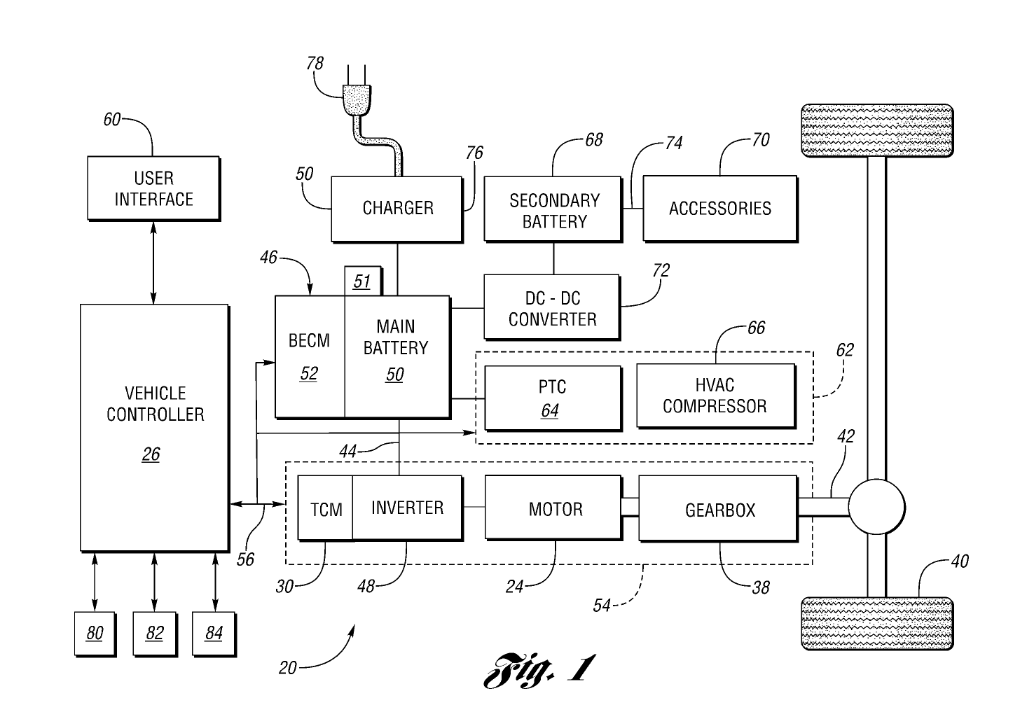

With reference to FIG. 1, an electric vehicle 20, such as a battery electric vehicle (BEV), is illustrated in accordance with one or more embodiments. FIG. 1 represents only one type of BEV architecture, and is not intended to be limiting. The present disclosure may be applied to any suitable BEV, as well as other hybrid vehicle architectures such as a plug-in electric hybrid (PHEV) having both an engine and an electric machine connected to a traction battery that is configured to be charged using an external power supply.

Referring to FIG. 1, the vehicle 20, or BEV, may be an all-electric vehicle propelled through electric power, such as by an electric motor 24, and without assistance from an internal combustion engine in the embodiment shown. The motor 24 receives electrical power and provides mechanical rotational output power. The motor 24 is connected to a gearbox 38 for adjusting the output torque and speed of the motor 24 by a predetermined gear ratio. The gearbox 38 is connected to a set of drive wheels 40 by an output shaft 42. Other embodiments of the vehicle 20 also include multiple motors (not shown) for propelling the vehicle 20. The motor 24 may also function as a generator for converting mechanical power into electrical power. A high voltage bus 44 electrically connects the motor 24 to an energy storage system 46 through an inverter 48.

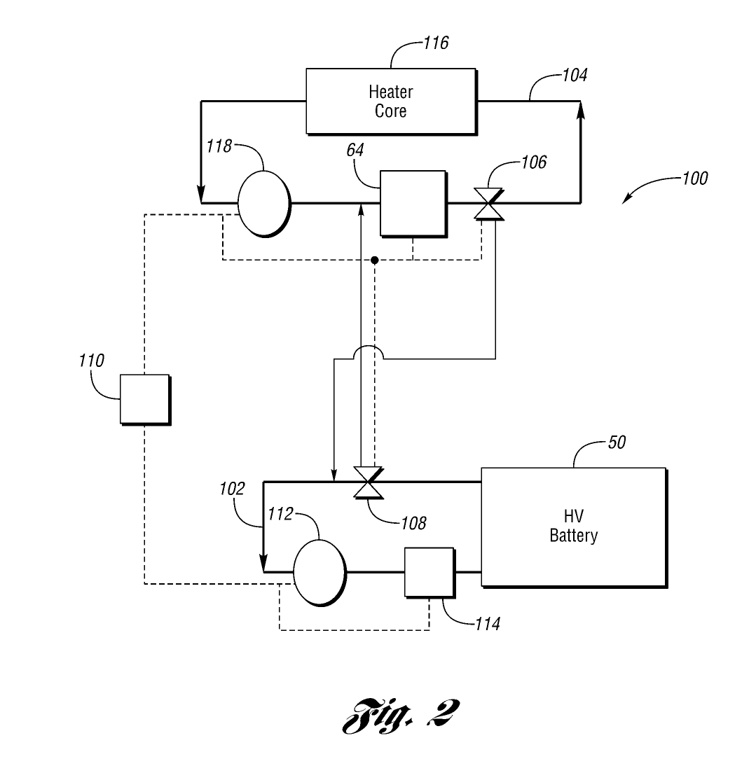

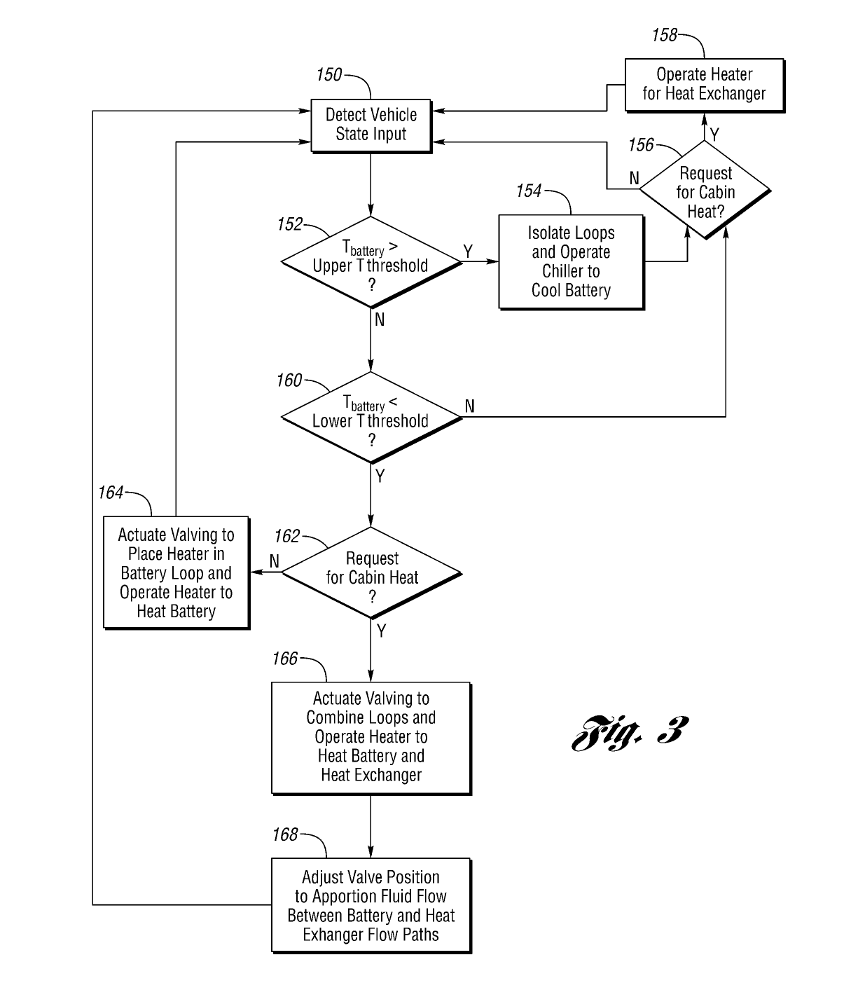

The energy storage system 46 includes a main battery 50 and a battery energy control module (BECM) 52, according to one or more embodiments. The main battery 50 is a high voltage battery, or traction battery, that may output electrical power to operate the motor 24. For example, the main battery 50 is a battery pack made up of one or more battery modules (not shown). Each battery module may contain one battery cell or a plurality of battery cells. The battery cells are heated and cooled using a coolant system and method as is described in greater detail with respect to FIGS. 2-3 below. The BECM 52 acts as a controller for the main battery 50. The BECM 52 also includes an electronic monitoring system that manages temperature and state of charge of each of the battery cells. The battery 50 has at least one temperature sensor, such as a thermistor or the like. The battery temperature sensor is in communication with the BECM 52 to provide temperature data regarding the battery 50.

The motor 24, the transmission control module (TCM) 30, the gearbox 38, and the inverter 48 are collectively referred to herein as a transmission 54. The vehicle controller 26 communicates with the transmission 54, for coordinating the function of the transmission 54 with other vehicle systems. The controller 26, BECM 52, and TCM 30 are illustrated as separate controller modules. The control system for the vehicle 20 may include any number of controllers, and may be integrated into a single controller, or have various modules. Some or all of the controllers may be connected by a controller area network (CAN) or other system. The control system may be configured to control operation of the various components of the transmission 54 and the battery 50 under any of a number of different conditions, including in a way that thermally manages the temperature in the battery 50 and the vehicle cabin or passenger compartment, and for charging and discharging operations of the battery 50.

The TCM 30 is configured to control specific components within the transmission 54, such as the motor 24 and/or the inverter 48. The vehicle controller 26 monitors the temperature of the motor 24 and receives a throttle request (or desired motor torque request) from the driver. Using this information the vehicle controller 26 provides a motor torque request to the TCM 30. The TCM 30 and the inverter 48 convert the direct current (DC) voltage supply by the main battery 50 into signals that are used to control the motor 24 in response to the motor torque request.

The vehicle controller 26 provides information to the driver through a user interface 60. The user interface may include features that permit a user to enter requirements or desired operating or charging parameters of the vehicle, or other vehicle operating parameters into the controller 26. The user interface may include a touch screen interface, a wireless connection to a remote station, such as a mobile device or computer, and other input interfaces as are known in the art. The vehicle controller 26 also receives input signals that are indicative of current operating conditions of vehicle systems. For instance, the vehicle controller 26 may receive input signals from the BECM 52 that represent battery 50 conditions, and input signals from the transmission 54, that represent motor 24 and inverter 48 conditions. The vehicle controller 26 is configured to provide an output to the user interface 60, such as a motor status or charge level status, which may be conveyed visually or audibly to the driver.

For example, the user may input a departure time, desired cabin temperature at departure, or the like, using the user interface 60, or to an interface in communication with the charger 76. Alternatively, the controller 26 may include a probabilistic or other logic module that determines a user's driving habits, including trip lengths, trip paths, departure times, cabin climate preferences, etc. The controller 26 arbitrates between the various user requests to thermally manage the vehicle 20 both on-charge and while operating.

The vehicle 20 includes a climate control system 62 for heating and cooling various vehicle components. The climate control system 62 includes a high voltage positive temperature coefficient (PTC) electric heater 64 and a high voltage electric HVAC compressor 66, according to one or more embodiments as are further described below with respect to FIG. 2. The PTC 64 and HVAC compressor 66 are used to heat and cool fluid, respectively, that circulates to the main battery 50. Both the PTC 64 and the HVAC compressor 66 may draw electrical energy directly from the main battery 50. The climate control system 62 may include a controller (not shown) for communicating with the vehicle controller 26 over the CAN bus 56 or may be integrated into the controller 26. The on/off status of the climate control system 62 is communicated to the vehicle controller 26, and can be based on, for example, the status of an operator actuated switch, or the automatic control of the climate control system 62 based on related functions, such as window defrost. The climate control system 62 may be connected to the user interface 60 to permit a user to set a temperature for the cabin, or pre-program a temperature for a future operating cycle of the vehicle.

The vehicle 20 includes a secondary battery 68, such as a 12-volt battery, according to one embodiment. The secondary battery 68 may be used to power various vehicle accessories such as headlights and the like, which are collectively referred to herein as accessories 70. A DC-to-DC converter 72 may be electrically disposed between the main battery 50 and the secondary battery 68. The DC-to-DC converter 72 adjusts, or “steps down” the voltage level to allow the main battery 50 to charge the secondary battery 68. A low voltage bus 74 electrically connects the DC-to-DC converter 72 to the secondary battery 68 and the accessories 70.

The vehicle 20 includes an AC charger 76 for charging the main battery 50. An electrical connector 78 connects the AC charger 76 to an external power supply (not shown) for receiving AC power. The AC charger 76 includes power electronics used to convert, or “rectify” the AC power received from the external power supply to DC power for charging the main battery 50. The AC charger 76 is configured to accommodate one or more conventional voltage sources from the external power supply (e.g., 110 volt, 220 volt, two phase, three phase, level 1, level 2, etc.) In one or more embodiments, the external power supply includes a device that harnesses renewable energy, such as a photovoltaic (PV) solar panel, or a wind turbine (not shown).

Also shown in FIG. 1 are simplified schematic representations of a driver controls system 80, a power steering system 82, and a navigation system 84. The driver controls system 80 includes braking, acceleration and gear selection (shifting) systems. The braking system includes a brake pedal, position sensors, pressure sensors, or some combination thereof, as well as a mechanical connection to the vehicle wheels, such as the primary drive wheels 40, to effect friction braking The braking system may also be configured for regenerative braking, wherein braking energy may be captured and stored as electrical energy in the main battery 50. The acceleration system includes an accelerator pedal having one or more sensors, which, like the sensors in the braking system, provides information such as the throttle request to the vehicle controller 26. The gear selection system includes a shifter for manually selecting a gear setting of the gearbox 38. The gear selection system may include a shift position sensor for providing shifter selection information (e.g., PRNDL) to the vehicle controller 26.

The navigation system 84 may include a navigation display, a global positioning system (GPS) unit, a navigation controller and inputs (all not shown) for receiving destination information or other data from a driver. The navigation system may be integrated with the user interface 60 in some embodiments. The navigation system 84 may also communicate distance and/or location information associated with the vehicle 20, its target destinations, or other relevant GPS waypoints.

FIG. 2 illustrates a thermal system 100 for use with vehicle 20 as shown in FIG. 1, or a vehicle according to another embodiment, such as another BEV architecture, a PHEV, or other electric or hybrid electric vehicle. A battery thermal cycle 102 may heat and cool the traction battery 50. A climate control system thermal cycle 104 heats air for the cabin, or in other embodiments, provides heating for another vehicle component. The loops 102, 104 share a common heater 64 for heating fluid in one or both of the loops 102, 104. The two thermal loops 102, 104 may be isolated from one another and operate independently, or may be selectively coupled for operation such that fluid in the loops flows between the two loops 102, 104 or partially between the two loops 102, 104. A valve arrangement, such as valves 106, 108, controls the fluid flow between the loops 102, 104 or acts to isolate the loops. A controller 110 controls the operation of the thermal system 100.

The thermal loop 102 thermally manages the battery 50 to regulate cell temperatures to maintain the battery 50 useful life, permit a proper charge, and meet vehicle performance attributes. The thermal loop 102 provides active heating or active cooling via liquid heat transfer for the battery 50. The thermal loop 102 contains a fluid that flows through cooling channels adjacent to the cells in the battery to heat or cool the battery 50 using primarily convective heat transfer. A pump 112 controls the flow of the fluid in the loop 102. The battery thermal loop 102 may also flow through the battery charger 76 to actively heat or cool the charger 76 and charging components.

The heater 64 acts as a thermal source to heat the fluid and in turn to actively heat the battery 50. The heating element 64 may be a heat exchanger in thermal communication with another thermal system in the vehicle to recover waste heat, or may be a stand-alone heater, such as a fuel combustion heater, or an electrically powered heater. The electrically powered heater may be a positive thermal coefficient (PTC) heater or another heater as is known in the art.

The battery thermal cycle 102 also has a chiller element 114, or thermal sink, that cools the fluid to actively cool the battery 50. The chiller 114 may be part of a vapor compression or absorption cycle, a heat exchanger in thermal communication with another element in a vehicle thermal system, or other thermal sink as is known in the art.

The thermal loop 104 provides heated air for the climate control system 62, or HVAC system. The loop 104 provides active heating and contains a fluid. In the embodiment shown, the fluid in loops 102, 104 is the same fluid, although different fluids with varying thermal and fluid properties may be used in other embodiments. The loop 104 provides heated fluid to a heat exchanger 116 which transfers heat between the heated fluid and air in the HVAC system to provide heated air to warm the passenger cabin, act to defrost or defog a window, and the like. The heat exchanger 116 may be a co-flow, counterflow, or other heat exchanger as is known in the art. The heater 64 acts as a thermal source to heat the fluid in loop 104 and in turn to provide heated fluid to the heater exchanger 116. A pump 118 controls the flow of the fluid in the loop 104.

The loops 102, 104 may have one or more degas bottles to trap vapors in the fluid and increase the thermal efficiency of the system 100. The degas bottle may be an air trap, separator, or other device as is known in the art. The degas bottle may also act as a fill location to add additional fluid to the system 100 as needed, such as during a service event. The loops 102, 104 may also have one or more fluid reservoirs as are known in the art.

The controller 110, which may be a vehicle controller in communication with or integrated with the battery control module 52, monitors the battery state, passenger cabin state, vehicle state, and any user requests and controls the system 100 in response. The controller 110 is configured to control the operation of the heater 64, the chiller 114, the pumps 112, 118 and the valves 106, 108 to provide heat to the climate system, and/or heating and cooling to the battery 50.

The controller 110 monitors the battery 50 to determine the state of charge and capacity of the battery 50, and the temperature of the cells in the battery using associated temperature sensors that are configures to measure the temperature of some or all of the cells in the battery. The controller 110 determines the temperature of the battery 50 by measuring or estimating the temperatures of the various battery cells. Alternatively, the controller 110 receives information regarding the battery 50 from the BECM 52.

The controller 110 is also in communication with the vehicle controller 26 to receive information regarding user requests or inputs to the HVAC system and cabin temperature. The cabin temperature is measured by a cabin temperature sensor to provide feedback for the HVAC system for climate control of the cabin.

The controller 110 is also in communication with an ambient temperature sensor on the vehicle or receives this information from the vehicle controller 26. The ambient temperature sensor is configured to measure the temperature of the ambient environment for use with either the thermal management of the battery 50 or the HVAC system.

The system 100 may be used in various configurations or modes. In one example, the battery loop 102 and the HVAC loop 104 are isolated from one another by actuating the valves 106, 108 into the appropriate configuration. The fluid remains in either loop 102 or 104, and does not cross over to the other loop when the system is in this configuration. Several modes of operation are available for the system 100 when the loops 102, 104 are isolated.

The battery loop 102 may provide active cooling to the battery 50, or may not be operated with the battery temperature permitting to change in a passive manner. If the loop 102 is commanded by the controller 110 to actively cool the battery 50, the pump 112 and chiller 114 are operated to circulate fluid within the loop 102 to cool the battery 50. Independently, the HVAC loop 104 may provide either active heating for the HVAC system via heat exchanger 116, or may not be operated and the cabin temperature permitting to change in a passive manner or be cooled using another subsystem in the HVAC. If the loop 104 is commanded by the controller 110 to actively provide heat for the climate control system, the pump 118 and heater 64 are operated to circulate fluid within the loop 104 to provide heated fluid to heat exchanger 116 and heat air for the climate system. Therefore, with the loops 102, 104 isolated by the valves 106, 108, loop 102 may be operating in a cooling mode, loop 104 may be operating in a heating mode, or both loops 102, 104 may be operating simultaneously.

In another example, the valves 106, 108 are actuated such that the heater 64 is incorporated into the battery loop 102, and the HVAC loop 104 is disabled. The fluid in the battery loop flows from the battery 50 through valve 108 to the heater 64, and then flows through valve 106 and back into the loop 102 and through the pump 112. Pump 112 operates to circulate the fluid in the loop 102. The battery loop 102 provides active heating to the battery 50.

In yet another example, the valves 106, 108 are actuated such that the battery loop 102 and the HVAC loop 104 are combined. The fluids in the two loops 102, 104 may mix between the loops 102, 104. The battery loop 102 may provide active heating to the battery 50, and the HVAC loop 104 may provide active hating for the heat exchanger 116 of the climate system. Fluid exits the heater 64 and flows through valve 106, where it is directed to continue along loop 104 and to loop 102. The fluid in loop 102 travels through the heat exchanger 116, through the pump 118 and back to the heater 64. The fluid directed to loop 102 flows through the pump 112, through the battery 50, and to valve 108, where it is directed combine with the other portion of fluid in loop 104 and flow through the heater 64. Based on the desired flow rate in the system 100, one or both pumps 112, 118 may be operated to circulate the fluid. If one pump is not operating, it may be commanded to freewheel, or bypass valving may be actuated, such that the flow of the fluid is minimally impacted.

In some embodiments, the valves 106, 108 may be valves that both directionally control the fluid as well as meter the fluid. The valves 106, 108 may be three way valves. The valves 106, 108 may be commanded to provide variable flow rates between the loops 102, 104. By changing the valve configuration, the proportion of fluid flow between the loops 102, 104 may be controlled. For example, if the combined flow exiting the heater 64 is 100 CFM (cubic feet per minute), the valve 106 may be controlled such that all of the flow goes to loop 104 and none to loop 102 (the isolated loops 102, 104 example). The valve 106 may also be controlled such that any percentage of the fluid flow goes to loop 104, and the remaining fluid flow goes to loop 102. For example, in a system with a 100 cfm (cubic feet per minute) flow rate exiting the heater 64, the valves 106, 108 may be controlled such that loop 102 has zero cfm directed to it by valve 106 and 100 cfm circulates in loop 104. Alternatively, the valves 106, 108 may be controlled such that loop 102 has fifty cfm and loop 104 has fifty cfm; loop 102 has ten cfm and loop 104 has ninety cfm, loop 102 has eighty cfm and loop 104 has 20 cfm, etc. The values are for representative purposes only, and other values for a combined flow rate, as well as other proportions of flow between loops 102, 104, are contemplated. The fluid flow rate may be varied by commanding the pumps 112, 118 to produce a different flow rate, i.e. a different speed in the case of a hydrostatic pump.

Other embodiments and configurations for the system 100 are also contemplated. For example, the battery thermal loop and the HVAC loop could be arranged such that fluid cannot cross over from one loop to the other. The two loops may flow through separate passageways in a common heater to heat fluid in one or both of the loops. In another example, the heater could be primarily positioned in the battery thermal loop, with valving arrangements that permit fluid from the HVAC loop to flow through the heater in the battery loop. These examples are non-limiting and represent various configurations and implementations of the present disclosure.

Referring to FIG. 3, a flow chart illustrates a method of using the system 100 according to an embodiment. The controller 110 detects various vehicle state inputs at 150, including battery 50 temperature, cabin temperature, ambient temperature, battery charge, on-plug and off-plug status, user requests, and other vehicle state inputs from the vehicle controller 26 or other vehicle system. If the battery temperature is above an upper threshold at 152, the controller 110 proceeds to 154 and isolates the loops 102, 104 from one another, and operates the chiller 114 and pump 112 to cool the battery 50. The controller 110 then proceeds to 156 and determines if heat for the HVAC system is requested for the heat exchanger 116. If there is a request for heat at 156, the controller 110 operates the heater 64 and the pump 118 to heat and circulate fluid in loop 104 at 158. The loops 102, 104 are isolated from one another using the valves 106, 108, and fluid is not transferred between the loops.

If the battery temperature is not above an upper temperature threshold at 152, the controller 110 proceeds to 160 to determine if the battery temperature is below a lower temperature threshold. If the battery temperature is not below the lower temperature threshold at 160, the controller 110 proceeds to 156 and determines if heat for the HVAC system is requested for the heat exchanger 116. If there is a request for heat at 156, the controller 110 operates the heater 64 and the pump 118 to heat and circulate fluid in loop 104 at 158. The loops 102, 104 are isolated from one another at this point using the valves 106, 108, and fluid is not transferred between the loops.

If the battery temperature is below the lower temperature threshold at 160, the controller 110 proceeds to 162 and determines if there is also a request for cabin heat or heat for the HVAC system. If there is no request for cabin heat at 162, the controller 110 proceeds to 164 and actuates the valves 106, 108 to place the heater 64 in fluid communication with the battery loop 102, and effectively disable loop 104. The controller 110 operates the heater 64 and the pump 112 to heat the battery 50.

If there is a request for cabin heat at 162, the controller 110 proceeds to 166 and actuates the valves 106, 108 to combine loops 102, 104 such that the fluid flows and may mix between both loops 102, 104. The controller 110 operates the heater 64 and at least one of the pumps 112, 118 to heat the battery 50 and provide heat to the heat exchanger 116. The controller 110 may adjust the valve positions at 168 to proportion the fluid flow between the loops 102, 104 to various degrees based on the amount and/or rate of heating desired for the battery 50 and the heat exchanger 116.

As such, various embodiments according to the present disclosure provide for a single heater to heat the battery and act as a heat source for the HVAC system, which reduces number of heaters on-board the vehicle and provides a higher power capability to meet thermal heating needs of the traction battery during cold temperature extremes. The valving arrangement between the battery thermal loop and the HVAC thermal loop allows for control over heat transfer to the battery and the heat exchanger of the HVAC system. For example, the valve arrangement may be controlled for variable or blended heating between the two loops based on the vehicle state and any user inputs.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments that are not explicitly illustrated or described. Where one or more embodiments have been described as providing advantages or being preferred over other embodiments and/or over prior art with respect to one or more desired characteristics, one of ordinary skill in the art will recognize that compromises may be made among various features to achieve desired system attributes, which may depend on the specific application or implementation. These attributes include, but are not limited to: cost, strength, durability, life cycle cost, marketability, appearance, packaging, size, serviceability, weight, manufacturability, ease of assembly, etc. As such, any embodiments described as being less desirable relative to other embodiments with respect to one or more characteristics are not outside the scope of the claimed subject matter.

What is claimed is:

1. A thermal system for an electric vehicle comprising:
an electric heat source;
a heat exchanger;
a traction battery;
a first thermal loop thermally coupled to the heat exchanger and thermally coupled to the heat source; and
a second thermal loop thermally coupled to the traction battery and configured to be selectively thermally coupled to the heat source.

2. The thermal system of claim 1 wherein the first thermal loop is configured to be in selective fluid communication with the second thermal loop.

3. The thermal system of claim 1 further comprising a controller configured to control the first and second thermal loops such that heat is provided to at least one of the heat exchanger and the traction battery.

4. The thermal system of claim 3 wherein the controller is configured to control the first and second thermal loops such that an amount of heat provided to the heat exchanger is independent of an amount of heat provided to the traction battery.

5. The thermal system of claim 1 wherein the heat exchanger is configured to provide heat to a passenger cabin of the vehicle.

6. The thermal system of claim 1 wherein the first thermal loop comprises a pump.

7. The thermal system of claim 1 wherein the second thermal loop comprises a pump and a chiller.

8. A vehicle comprising:
an electric heat source;
a heat exchanger system configured to be selectively thermally coupled with the electric heat source; and
a traction battery system configured to be selectively thermally coupled to the electric heat source.

9. The vehicle of claim 8 further comprising a first thermal loop in fluid communication with the electric heat source and the heat exchanger.

10. The vehicle of claim 9 further comprising a second thermal loop in fluid communication with the battery and in selective fluid communication with the electric heat source, wherein the second thermal loop is in selective fluid communication with the first thermal loop.

11. The vehicle of claim 10 further comprising a valve arrangement connecting the first and second thermal loops.

12. The vehicle of claim 11 further comprising a controller configured to control the valve arrangement such that heat is provided to at least one of the heat exchanger and the traction battery.

13. The vehicle of claim 12 wherein the controller is configured to control the valve arrangement such that an amount of heat provided to the heat exchanger is independent of the amount of heat provided to the traction battery.

14. The vehicle of claim 12 wherein the controller is configured to control the valve arrangement based on a state of the vehicle.

15. The vehicle of claim 14 wherein the state is one of off-plug, on-plug, and driving.

16. The vehicle of claim 8 wherein the electric heat source is a positive thermal coefficient (PTC) heater.

17. A method of controlling a battery electric vehicle comprising:
detecting a vehicle state input;
operating an electric heater to heat a fluid; and
actuating a valve arrangement in response to detecting the vehicle state input to provide the fluid to at least one of a traction battery through a first fluid conduit and a heat exchanger through a second fluid conduit.

18. The method of claim 17 further comprising controlling the valve arrangement such that an amount of fluid provided through the first conduit is independent of an amount of fluid provided through the second conduit.
